(19) United States
(12) Patent Application Publication
(10) Pub. No.: US 2015/0314636 A1
(43) Pub. Date: Nov. 5, 2015

(54) Method and Apparatus for Creating Die-Cut Traceable Repetitive Designs

(71) Applicant: Michael Conner, West Chester, OH (US)

(72) Inventor: Michael Conner, West Chester, OH (US)

(21) Appl. No.: 14/700,930

(22) Filed: Apr. 30, 2015

Related U.S. Application Data
(60) Provisional application No. 61/987,224, filed on May 1, 2014.

(51) Int. Cl. B43L 13/20

(52) U.S. Cl. CPC B43L 13/205

(57) ABSTRACT

The present disclosure contemplates a book of templates that are die-cut stamped traceable designs that allow users to draw an exact outline of a various repetitive designs such as snowflakes. In one embodiment the present disclosure contemplates an apparatus with traceable templates produced using a die-cutting manufacturing process. In this embodiment the apparatus may also include a final product medium made of paper. In this embodiment the apparatus may yield an ultimate design that is a repetitive design such as a snowflake. The die-cut traceable templates provide a fractional outline of ultimate designs where the fraction of the design is repeated in a circular fashion to yield the ultimate design. In another embodiment a series of die-cut traceable templates may be included in a book where each die-cut traceable template may have a different repetitive design that may be traced on to a final product medium. In another embodiment the present disclosure contemplates a method of creating repetitive craft designs using die-cut traceable templates. In this embodiment the method includes various tracing, folding, and cutting steps which render an ultimate repetitive design.

### RELATED APPLICATIONS

This application claims priority under 35 U.S.C. §119 based on U.S. Provisional Application No. 61/987,224, filed on May 1, 2014, the disclosure of which is incorporated herein by reference.

### FIELD OF INVENTION

The present disclosure contemplates a method and apparatus for creating repetitive designs by utilizing a die-cut traceable template. The present disclosure further contemplates a book of templates that are die-cut stamped traceable designs that allow users to draw an exact outline of a various repetitive designs such as snowflakes.

### BACKGROUND

The present disclosure provides a much easier way to trace the templates onto the user's crafting medium when creating repetitive designs. The die-cut traceable template may constitute a fraction, such as one-sixth or one-eighth, of the entire design. The user may fold a final product medium, such as paper, and cut out the traced shapes to produce an ultimate design. The fraction of the outline of the ultimate design may be stamped out of a traceable template medium, such as cardstock. The user may put the final product medium under the die-cut traceable template to more accurately trace the design onto the final product medium in conjunction with a series of folding, cutting, and unfolding steps by the user on the final product medium to replicate the repetitive design.

The present disclosure provides an accessible and affordable avenue for people who wish to decorate offices, classrooms, or homes with repetitive designs, such as snowflakes. While the prior art contemplates design books that have templates in which the user lays a piece of paper over the design to trace onto paper before cutting, with the present disclosure the user may put a final product medium under the die-cut traceable template to more accurately trace the design onto the final product medium prior to folding and cutting. The present disclosure provides an easier and more accurate way to trace the templates onto the final product medium to create the ultimate design. The die-cut traceable templates allow the user to trace a more precise copy of the image they are trying to translate to paper for the purpose of cutting out an ultimate repetitive design because the edges of the die-cut traceable templates are smoother, straighter, and cleaner than templates produced by other production methods. The production of templates using a die-cut stamping process also reduces production costs as the templates may be produced in more efficient manner.

In one embodiment the present disclosure contemplates an apparatus which may include the traceable template may be made of cardstock and produced using a die-cutting manufacturing process. In this embodiment the apparatus may also include a final product medium made of paper. In this embodiment the apparatus may yield an ultimate design that is a repetitive design such as a snowflake. The cardstock traceable template may outline a fraction of the ultimate design where the fraction of the design is repeated in a circular fashion to yield the ultimate design. The apparatus in this embodiment may allow a user to place paper final product medium beneath the cardstock traceable template in a manner such that the user may then trace the repetitive design formed by the cardstock traceable template on to the paper final product medium.

In another embodiment a series of die-cut traceable templates may be included in a book where each die-cut traceable template may have a different repetitive design that may be traced on to a final product medium.

In another embodiment the present disclosure contemplates a method of creating repetitive craft designs using die-cut traceable templates. In this embodiment the method includes various tracing, folding, and cutting steps which render an ultimate repetitive design. In the tracing steps of this embodiment the outline may be traced on the final product medium by the user using the die cut traceable template. In the folding steps, the final product medium may be folded in a series of manipulations based on the fraction of the ultimate design shown in the die-cut traceable template. In the cutting steps the final product medium may be cut based on the outline on the final product medium from the tracing steps. After the cutting steps the final product medium may be unfolded to render the ultimate repetitive design.

### BRIEF DESCRIPTION OF THE DRAWINGS

The foregoing and other features of the present disclosure will become more fully apparent from the following description, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 depicts a side perspective view of an exemplary die-cut traceable template.

FIG. 2 depicts a side perspective view of an exemplary die-cut traceable template and an exemplary final product medium.

FIG. 3 depicts a side perspective view of an exemplary die-cut traceable template with an exemplary final product medium placed beneath the die-cut traceable template.

FIG. 4 depicts a side perspective view of an exemplary die-cut traceable template with an exemplary final product medium placed beneath the die-cut traceable template while a user traces the outline of the repetitive design from the die-cut traceable template on to the final product medium.

FIG. 5 depicts a side perspective view of an exemplary die-cut traceable template with an exemplary final product medium where the outline of the repetitive design from the die-cut traceable template traced by the user on to the final product medium.

FIG. 6 depicts a side perspective view of an exemplary die-cut traceable template with an exemplary final product medium where the outline of the repetitive design from the die-cut traceable template traced by the user on to the final product medium and the final product medium has been folded.

FIG. 7 depicts a side perspective view of an exemplary die-cut traceable template with an exemplary final product medium where the outline of the repetitive design from the die-cut traceable template traced by the user on to the final product medium and the final product medium is being cut.

FIG. 8 depicts a side perspective view of an exemplary die-cut traceable template with an exemplary final product medium where the outline of the repetitive design from the die-cut traceable template traced by the user on to the final product medium and the final product medium has been cut.

FIG. 9 depicts a side perspective view of an exemplary die-cut traceable template with an exemplary final product medium showing the ultimate repetitive design.

FIG. 10 depicts a flow chart showing the steps of an exemplary method for creating repetitive designs by utilizing a die-cut traceable template.

### DETAILED DESCRIPTION

In the following detailed description, reference is made to the accompanying drawings, which form a part hereof. In the drawings, similar symbols typically identify similar components, unless context dictates otherwise. The illustrative embodiments described herein are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

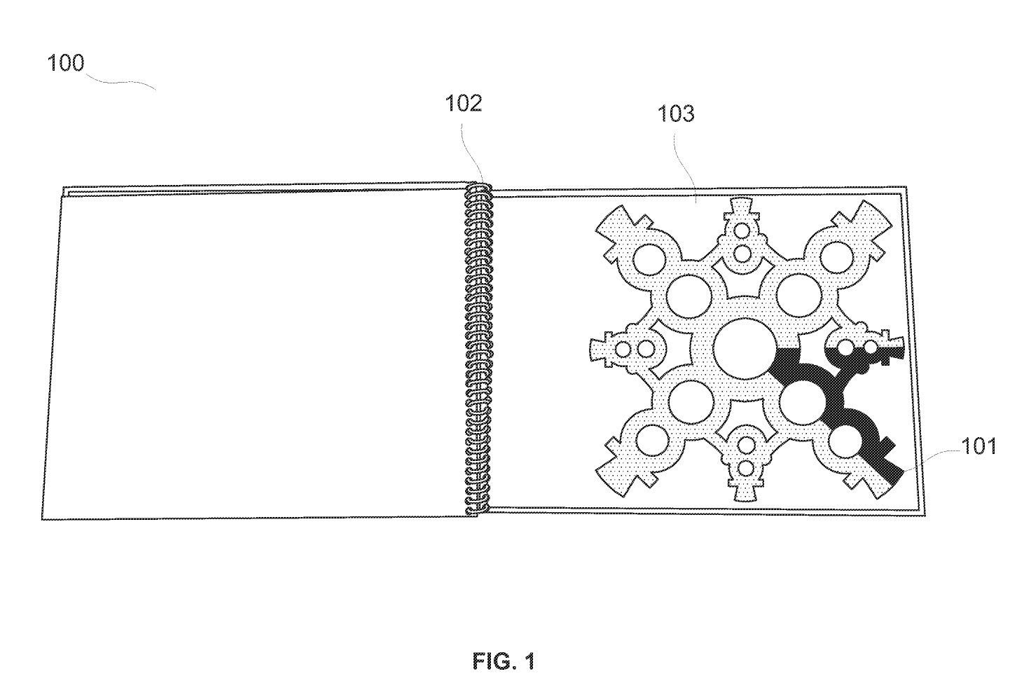

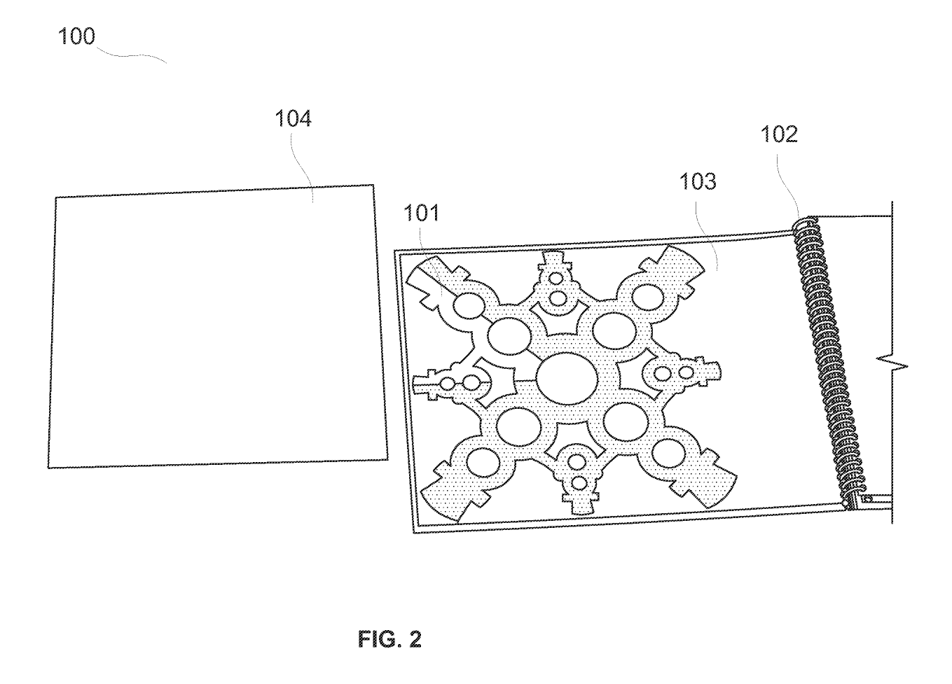

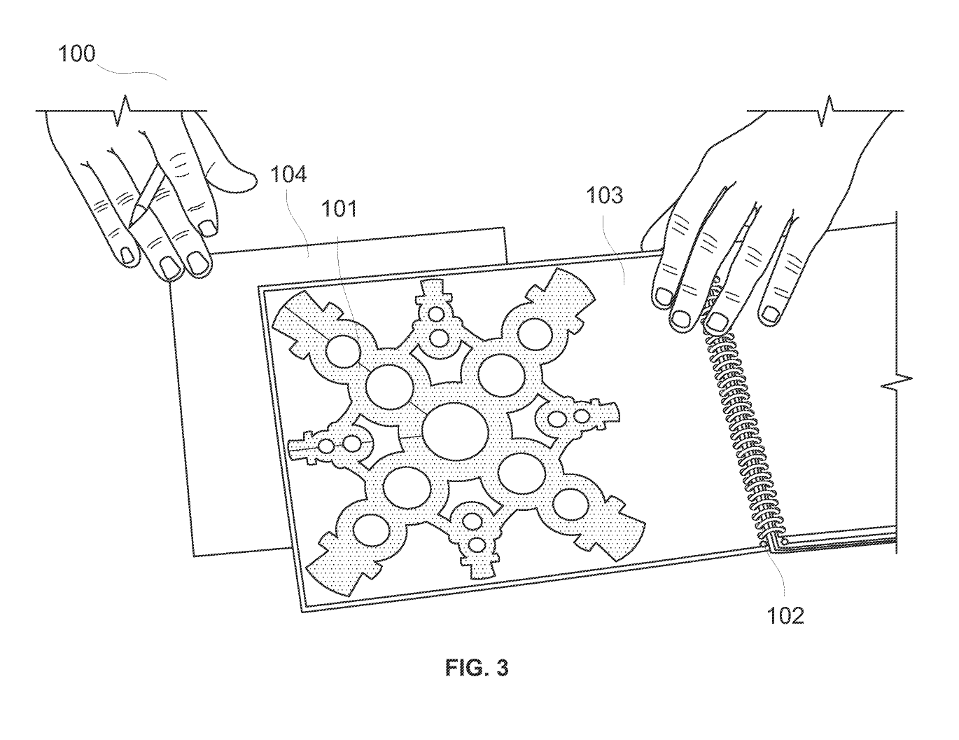

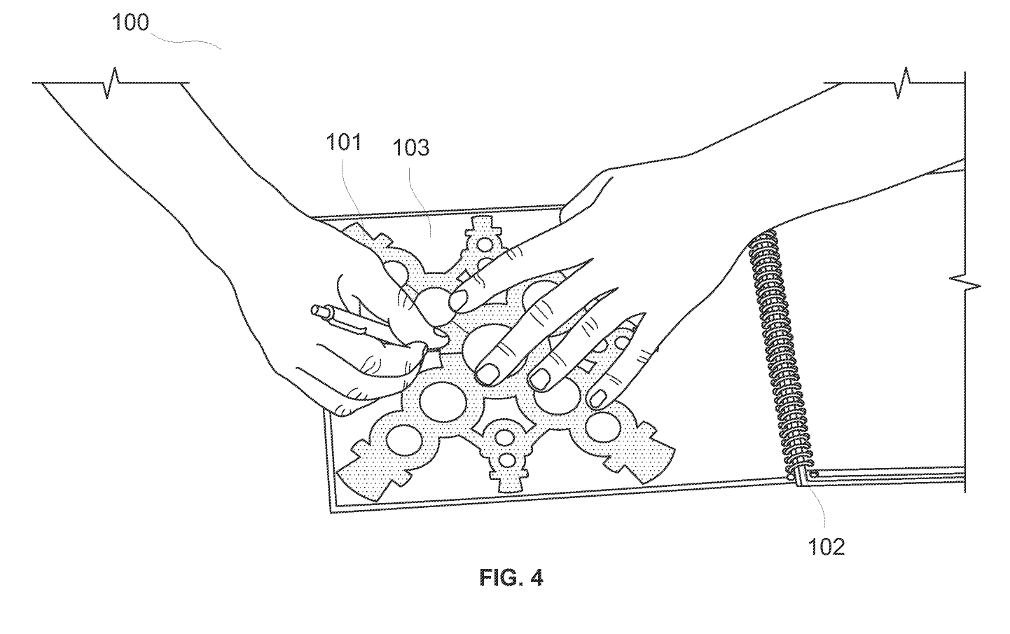

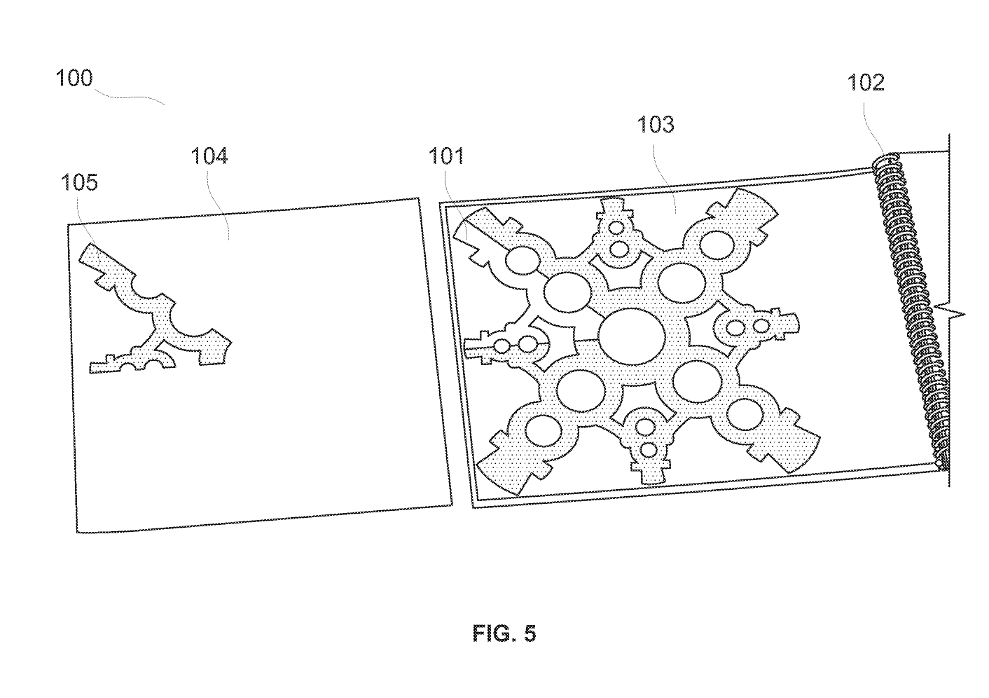

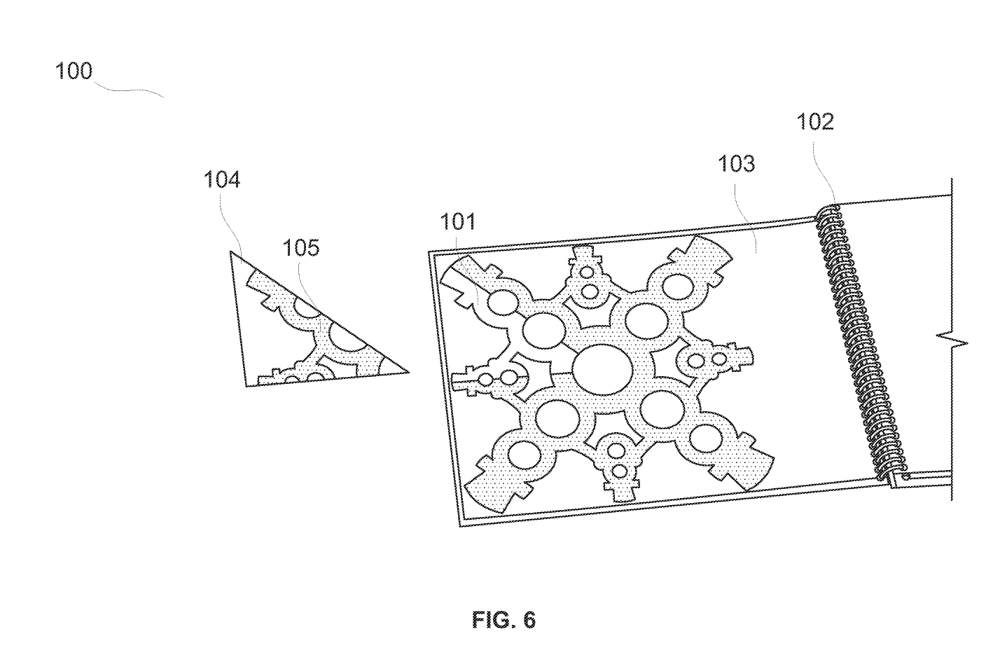

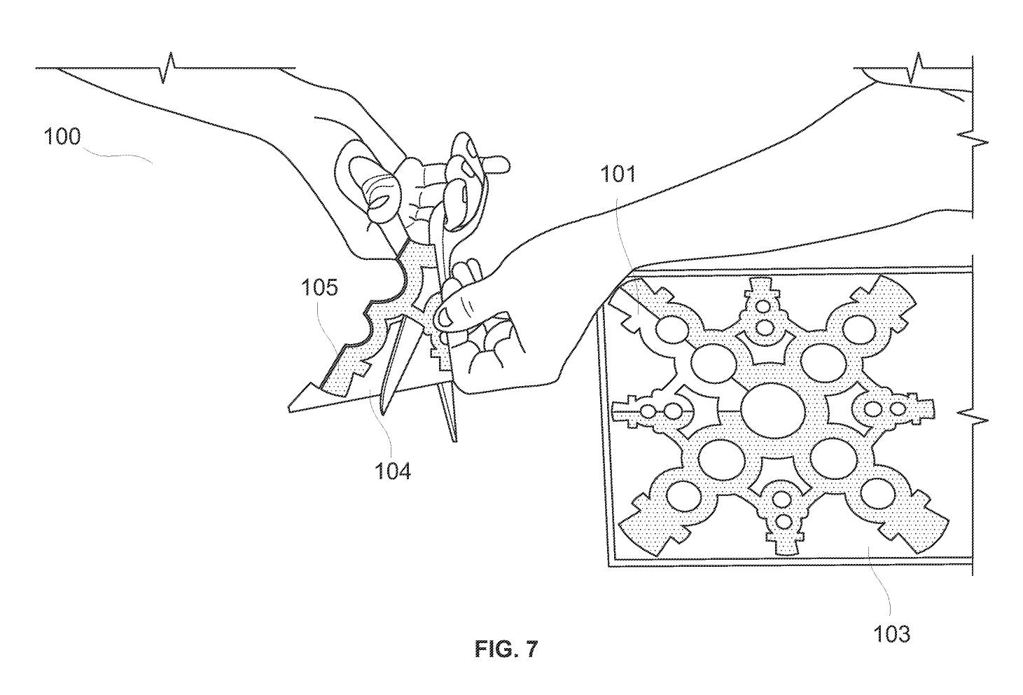

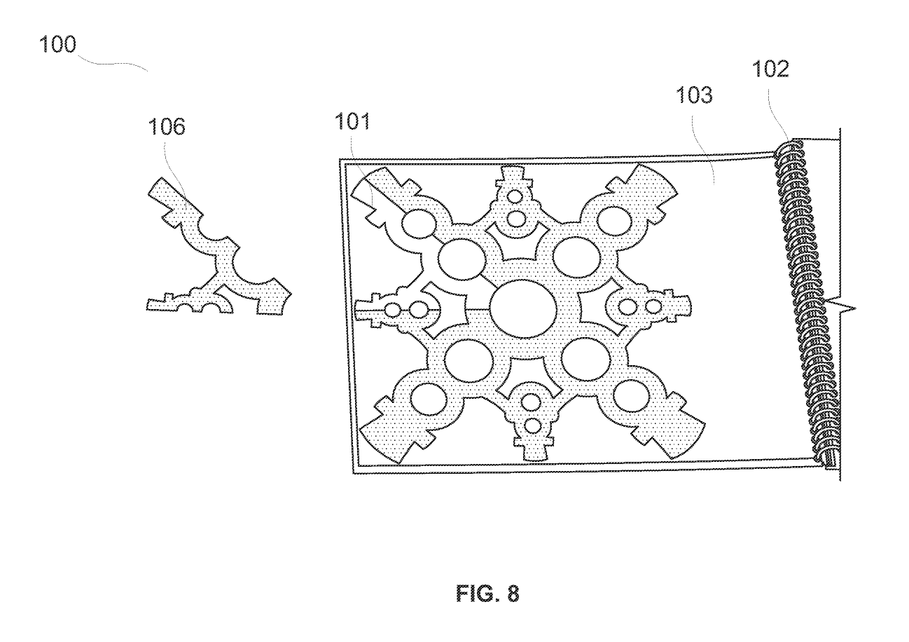

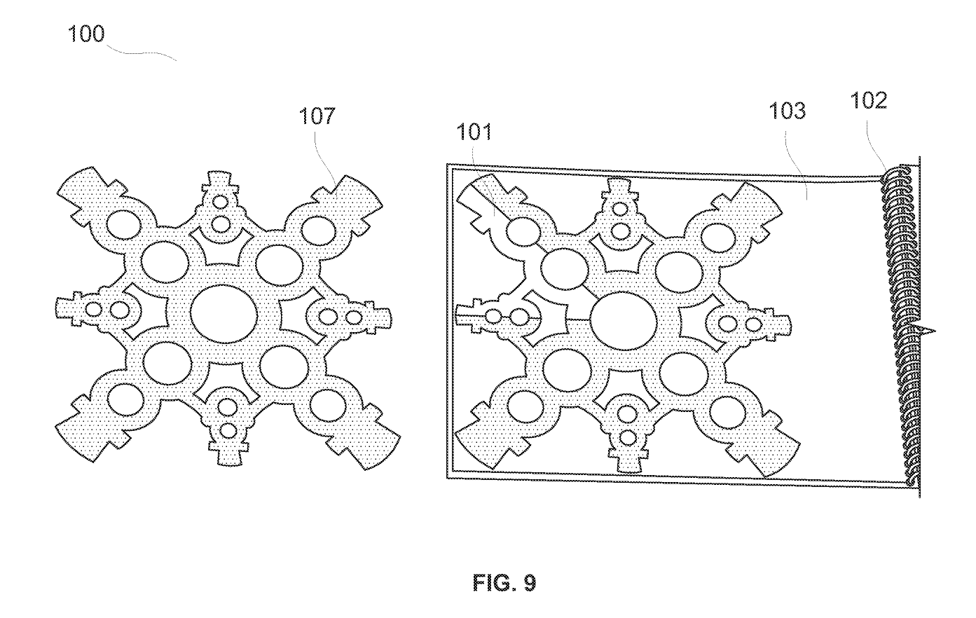

FIGS. 1-9 depict a side perspective view of an exemplary apparatus for creating precise repetitive designs 100. The exemplary apparatus for creating precise repetitive designs 100 may include a plurality of die-cut traceable templates 103. The plurality of die-cut traceable templates 103 may be joined in book with a binding 102. The plurality of die-cut traceable templates 103 may provide a fractional outline 101 for creating a traced portion of a repetitive design 105 on a final product medium 104. The final product medium 104 may be folded and a user may cut along the traced portion of the repetitive design 105 to create a folded portion of the repetitive design 106 before unfolding to form the ultimate repetitive design 107. In this embodiment the exemplary die-cut traceable template 103 provides a fractional outline 101 for a repetitive snowflake design where one-eighth of the ultimate repetitive design is included in the die-cut traceable template 103. The depicted embodiment shows one die-cut traceable template 103 included in a book of die-cut traceable templates where each die-cut traceable template 103 provides a traceable fractional outline 101 for different ultimate repetitive design 107. In an alternative embodiment the die-cut traceable template 103 may be a separate apparatus that is not bound in a book with other die-cut traceable templates 103. In alternative embodiments the die-cut traceable template 103 may contain another fraction of the ultimate repetitive design 107, such as one-fourth, one-sixth, or one-tenth of the ultimate repetitive design 107. In alternative embodiments the final product medium 104 may be different grades of paper products or plastic products and the ultimate repetitive design 107 may be any number of aesthetically pleasing patterns. Likewise in alternative embodiments the die-cut traceable templates 103 may consist of different grades of paper, plastic or metal materials.

FIGS. 1-9 also depict a side perspective view of exemplary apparatus for creating precise repetitive designs 100 including die-cut traceable templates 103 and an exemplary final product medium 104 where the final product medium undergoes a series of tracing 105, folding, cutting 106, and unfolding steps to produce the ultimate repetitive design 107. Again, in this embodiment the exemplary die-cut traceable template 103 provides a fractional outline 101 for a repetitive snowflake design 107 where one-eighth of the ultimate repetitive design is included in the die-cut traceable template 103.

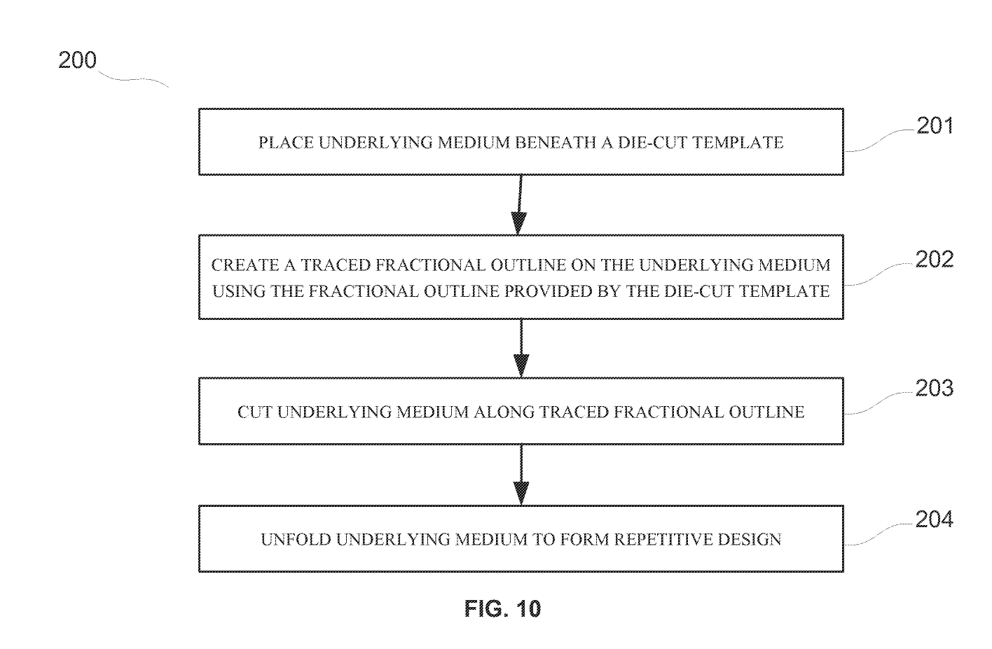

FIG. 10 depicts a flow chart showing the steps of an exemplary method for creating repetitive designs by utilizing a die-cut traceable template. The exemplary method of FIG. 10 may include placing an final product medium beneath a die-cut traceable template 201, creating a traced fractional outline on the final product medium using the fractional outline provided by the die-cut traceable template 202, cutting the final product medium along the traced fractional outline 203, and unfolding the final product medium to form the repetitive design 204. For the exemplary method the die-cut traceable template 103 provides a fractional outline 101 for a repetitive designs 107 and the user may use a plurality of die-cut traceable templates 103 bound together 102 to created many different ultimate repetitive designs 107 on a final product medium 104.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. An apparatus for creating precise repetitive designs comprising:
a plurality of die-cut traceable templates bound together;
wherein the plurality of die-cut traceable templates provide different fractional outlines for repetitive designs;
wherein tracing the fractional outlines to an underlying medium transfers the repetitive designs to the final product medium.

2. The apparatus of claim 1, wherein the plurality of die-cut traceable templates are comprised of cardstock paper.

3. The apparatus of claim 1, wherein the plurality of die-cut traceable templates are comprised of metal.

4. The apparatus of claim 1, wherein the final product medium is comprised of paper.

5. The apparatus of claim 1, wherein the plurality of die-cut traceable templates are bound together along with a front cover and a back cover.
wherein the front cover and the back cover do not contain fractional outlines.

6. The apparatus of claim 5, wherein the plurality of die-cut traceable templates are bound with the final product medium.

7. The apparatus of claim 1, wherein the plurality of die-cut traceable templates provides fractional outlines comprising one-fourth of the repetitive designs.

8. The apparatus of claim 1, wherein the plurality of die-cut traceable templates provides fractional outlines comprising one-sixth of the repetitive designs.

9. The apparatus of claim 1, wherein the plurality of die-cut traceable templates provides fractional outlines comprising one-eighth of the repetitive designs.

10. The apparatus of claim 1, wherein the plurality of die-cut traceable templates provides fractional outlines comprising one-tenth of the repetitive designs.

11. A method for creating precise repetitive designs comprising:
placing an final product medium beneath a die-cut traceable template, wherein the die-cut traceable template provides a fractional outline for a repetitive design;
creating a traced fractional outline on the final product medium using the fractional outline provided by the die-cut traceable template;
cutting the final product medium along the traced fractional outline;
unfolding the final product medium to form the repetitive design.
